(19) United States
(12) Patent Application Publication
(10) Pub. No.: US 2007/0157774 A1
(43) Pub. Date: Jul. 12, 2007

(54) Tool head as seat and drive for a tool and tool for use in the tool head

(75) Inventors: Andreas Gross, Marbach (DE); Kurt Kleinbach, Beilstein (DE); Klaus Peiffer, Wallisellen (CH)

Correspondence Address: THE GLEASON WORKS, 1000 UNIVERSITY AVENUE, P O BOX 22970, ROCHESTER, NY, 146922970, US

(73) Assignee: Gleason-Pfauter Maschinenfabrik GmbH

(21) Appl. No.: 11/641,474

(22) Filed: Dec. 19, 2006

(30) Foreign Application Priority Data
Jan. 3, 2006 (DE) 10 2006 001 026.4

(51) Int. Cl. B23B 3/00

(52) U.S. Cl. 82/117

(57) ABSTRACT

Tool head as seat and drive for the rotary motion of a tool to be bilaterally supported in the tool head. Near its ends, the tool has centering faces which fit into rotatably developed seat bushings in the tool head. One of said seat bushings is arranged in a drive carriage and the other in a counter-bearing, in alignment with each other. The counter-bearing is part of a counter-bearing carriage which can be displaced far enough on the drive carriages to seat the tool so that the tool, which is located between the carriages, is held with the centering faces in the bushings and a pre-adjusted axial force is present. A rotary drive motor is connected to the tool via a tool spindle supported in the drive carriage and a positive clutch. The tool is preferably developed as a shaft tool and is essentially symmetrical relative to a plane perpendicular to the axis of rotation in the center of a gear cutting enveloping body of the tool. The distance between the centering face and the gear cutting enveloping body on the drive side is as small as the required minimum corresponding distance on the side of the counter bearing.

### FIELD OF THE INVENTION

The invention relates to a tool head as seat and drive for the rotary motion of a tool such as in a gear manufacturing machine and a tool for use in said tool head.

### BACKGROUND OF THE INVENTION

In general, tool heads are required, for example, for disk-shaped or helical tools for machining cylindrical gear wheels. Collet chucks are frequently used as seat and to drive the tool, but said collet chucks are sensitive to soiling, wear and tear and damage. Collet chucks furthermore require a high geometrical effort and narrow machining tolerances. In addition, if high torques must be applied, positive locking may also be required. The tools require complicated counter-bearings which often have little stiffness. High clamping forces are required to clamp the tools, because the tools are driven non-positively, at least when higher accuracy of movement is required. Because the necessary force to produce and/or release the clamping force for tools requires space in the direction of the rotary axis of the tool, this also requires a great overall length. This therefore results in unfavorable spatial conditions for the mounting and maintenance of the angular position measuring system required to control the tool rotation.

The object of the invention is to develop a tool head and tool so that the tool head is sturdy and reliable without the disadvantage of the collet chucks, permits tool movement accuracy, provides a rigid counter-bearing, has short overall length and presents favorable conditions for the mounting and maintenance of an angular position measuring system.

In the tool head in accordance with the invention, the counter-bearing is part of a counter-bearing carriage that can be displaced in the direction of the drive carriage to seat the tool so that the tool with its centering faces is held between the two carriages in the bushings. In doing so, a pre-adjusted axial force is present. The rotary drive motor is connected to the tool through the tool spindle supported in the drive carriage and by a positive clutch. This development, which does not require a collet chuck, results in a compact design of the tool head and high tool movement accuracy. Compared to the state of the art, the counter-bearing comprises only a few structural elements and can therefore be developed particularly rigid. The conditions for the mounting and maintenance of the angular position measuring system are thus favorable.

In the present invention, the drive spindle can have a smaller diameter than required in the state of the art. This is attributable to the fact that on the one hand, the inventive tool head uses a space-saving positive clutch instead of a collet chuck and on the other hand, that working with a collet chuck requires higher clamping forces.

The dimensions of the drive carriage can therefore be smaller on the tool side than those of the state of the art. In this way, the active area of the tool can be positioned closer to the nose of the spindle, without the drive carriage colliding with the work piece or the chuck.

Because of the fact that the inventive tool head does not operate with a fixed counter-bearing with a spindle sleeve but with a counter-bearing carriage, the tool head permits the use of different tools of significantly varied lengths. The counter-bearing itself is comprised of only a few elements and can therefore be developed particularly rigid.

The shank tools corresponding to the state of the art, which are presently often used, i.e., the tools that are not connected to the drive spindle via a separate mandrel, have a greater distance between the toothing and the mounting surface on the drive side than on the counter-bearing side. However, because of the aforementioned developments, the present invention permits a symmetrical development of the tools with little distance between the toothing and the mounting surfaces. In this context, it goes without saying that symmetry does not refer to the individual teeth but rather to symmetry with respect to the gear enveloping body of the tool.

### SUMMARY OF THE INVENTION

Tool head as seat and drive for the rotary motion of a tool to be bilaterally supported, such as by bearings, in the tool head. Near its ends, the tool has centering faces which fit into rotatably developed seat bushings in the tool head. One of said seat bushings is arranged in a drive carriage and the other in a counter-bearing, with the drive carriage and counter-bearing being in alignment with each other. The counter-bearing is part of a counter-bearing carriage which can be displaced far enough with respect to the drive carriage to seat the tool so that the tool, which is located between the carriages, is held with the centering faces in the bushings and a pre-adjusted axial force is present. A rotary drive motor is connected to the tool via a tool spindle supported in the drive carriage and a positive clutch. The tool is preferably developed as a shaft tool and is essentially symmetrical relative to a plane perpendicular to the axis of rotation in the center of a gear cutting enveloping body of the tool. The distance between the centering face and the gear cutting enveloping body on the drive side is as small as the required minimum corresponding distance on the side of the counter bearing.

### BRIEF DESCRIPTION OF THE DRAWINGS

FIG. 1 is a view of a tool head in accordance with the invention with a clamped tool.

FIG. 2 illustrates a horizontal section of the tool head in accordance with the invention through the axis of rotation of the tool.

FIG. 3 shows a section of the drive of the threaded spindle to displace the counter-bearing and the drive carriages relative to one another.

FIG. 4 illustrates a means for adjusting the axial force between the tool and the two carriages of the tool head in accordance with the invention.

FIG. 5 shows a partial view and a partial section of a positive clutch between the tool spindle and the tool of the tool head in accordance with the invention.

FIG. 6 is a view of the positive clutch in accordance with FIG. 5.

FIG. 7 is a perspective view of a thrust piece of the positive clutch in accordance with FIG. 5.

FIG. 8 illustrates a lateral view of the tool held in the tool head in accordance with the invention with the tool-side portion of the clutch according to FIG. 5.

FIG. 9 shows a top view of the tool according to FIG. 8 with the tool-side portion of the clutch according to FIG. 5.

FIG. 10 shows the tool according to FIG. 8 in a position rotated 90° around its axis with the tool-side portion of the clutch according to FIG. 5.

FIGS. 11(a)-11(c) illustrate various embodiments of the clutch according to FIGS. 5 and 6.

### DETAILED DESCRIPTION OF THE PREFERRED EMBODIMENTS

The details of the present invention will now be discussed with reference to the drawings which represent the invention by way of example only.

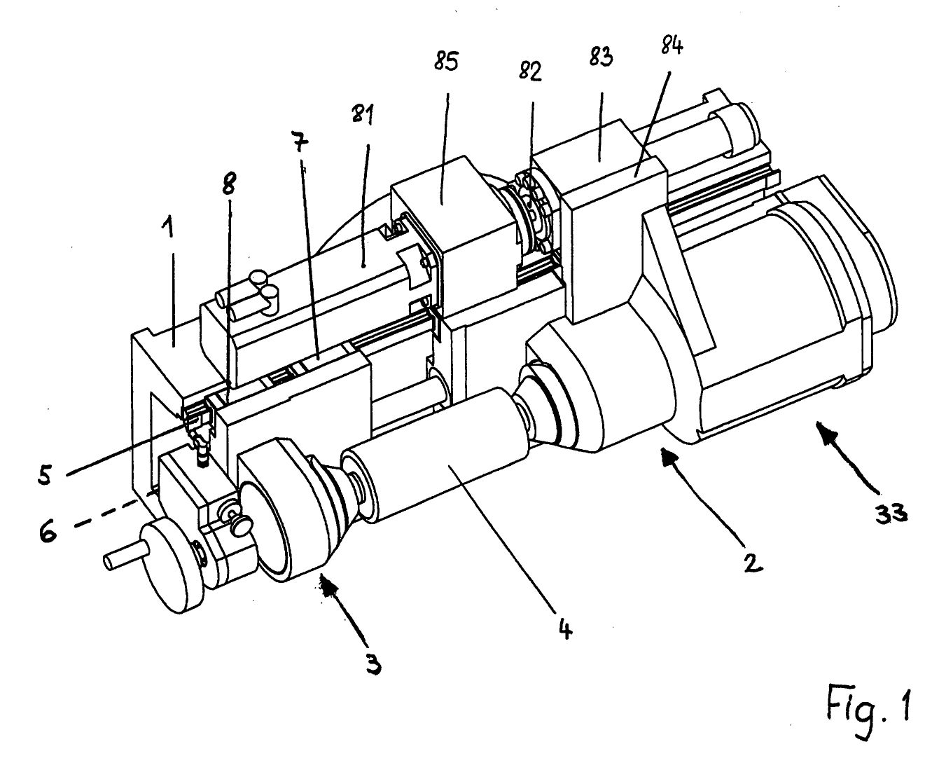

The tool head comprises a housing 1 with two attached parallel running linear guide tracks in various heights. FIG. 1 shows only the upper guide track 5. The lower guide track 6 is obscured. A drive carriage 2 and a counter-bearing carriage 3 are displaceably arranged on the guide tracks 5, 6. Four each guide rollers connect the two carriages 2, 3 to the guide tracks 5, 6, i.e., two for the connection to the upper guide track 5 and two for the connection to the lower guide track 6. FIG. 1 shows only the two guide rollers 7 and 8 that connect the counter-bearing carriage 3 with the upper guide track 5. The remaining guide rollers are obscured.

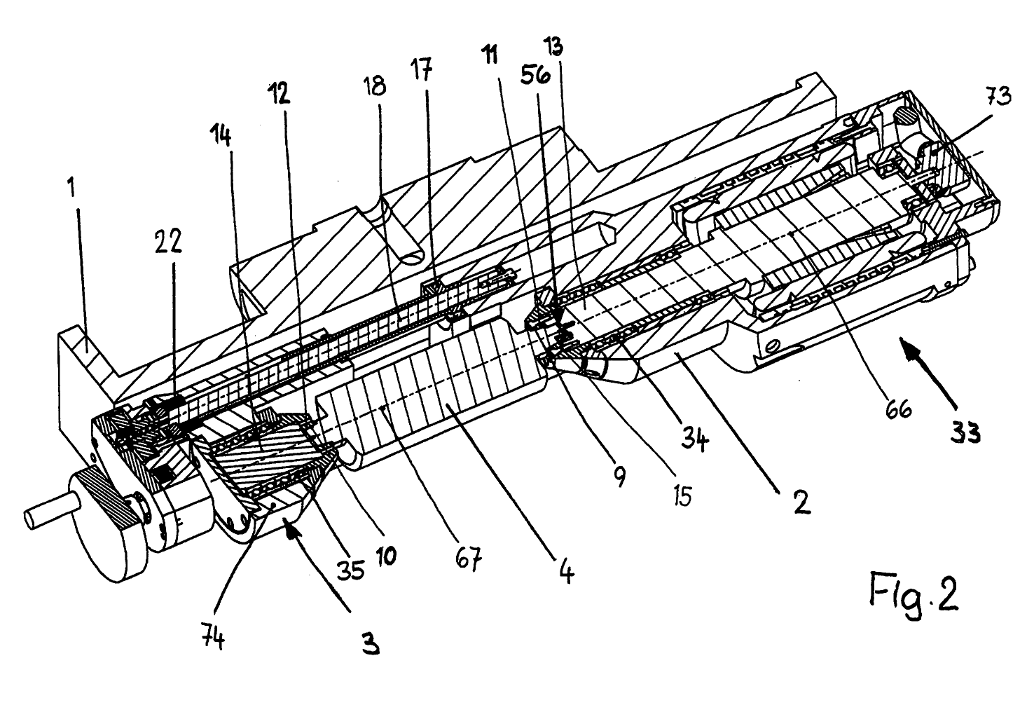

The tool head seats a tool 4 which has conical centering faces 9 on the side of the drive carriage and 10 on the side of the counter-bearing near its two ends (FIG. 2). The centering faces 9, 10 fit into correspondingly developed interior surfaces of the conical bushings 11 and 12. The conical bushing 11 is splined to a drive spindle 13 to prevent rotation and the conical bushing 12 is splined to a counter-bearing spindle 14 to prevent rotation, preferably with a screw connection. One of the screws for fastening the conical bushing 11 is designated as 15 (FIG. 2). The screws for fastening the conical bushing 12 are not shown. A rotary drive motor 33 is used to rotate the drive spindle 13 (FIGS. 1 and 2).

A spindle nut 17 affixed to the drive carriage 2 engages with a threaded spindle 18 positioned in the counter-bearing carriage 3 (FIG. 2). The diameter of the left end of the threaded spindle 18 is smaller in order to form a cylindrical pivot 76 and a shoulder 77 (FIG. 3). A thrust collar 19 is located on the pivot 76, which bears against the shoulder 77 by means of a basic locking element 28. The basic locking element 28 is connected to the threaded spindle 18 by means of the screws 31, 32.

The thrust collar 19 has an axial longitudinal groove 24 on the outer cylinder. A setscrew 25 with a cylindrical pivot 26 projects from the counter-bearing carriage 3 into said longitudinal groove and thus prevents the rotation of the thrust collar 19. The thrust collar 19 can therefore move only in the direction of the axis of rotation 27 of the threaded spindle 18. The connection between threaded spindle 18, thrust collar 19 and basic locking element 28 permits the rotation of the threaded spindle 18 in the bore 78 of the thrust collar 19. The thrust collar 19 is supported on a radial support surface 23 provided in an axial bore 20 in the counter-bearing carriage 3 by at least one spring 22, which in the embodiment is a disk spring set.

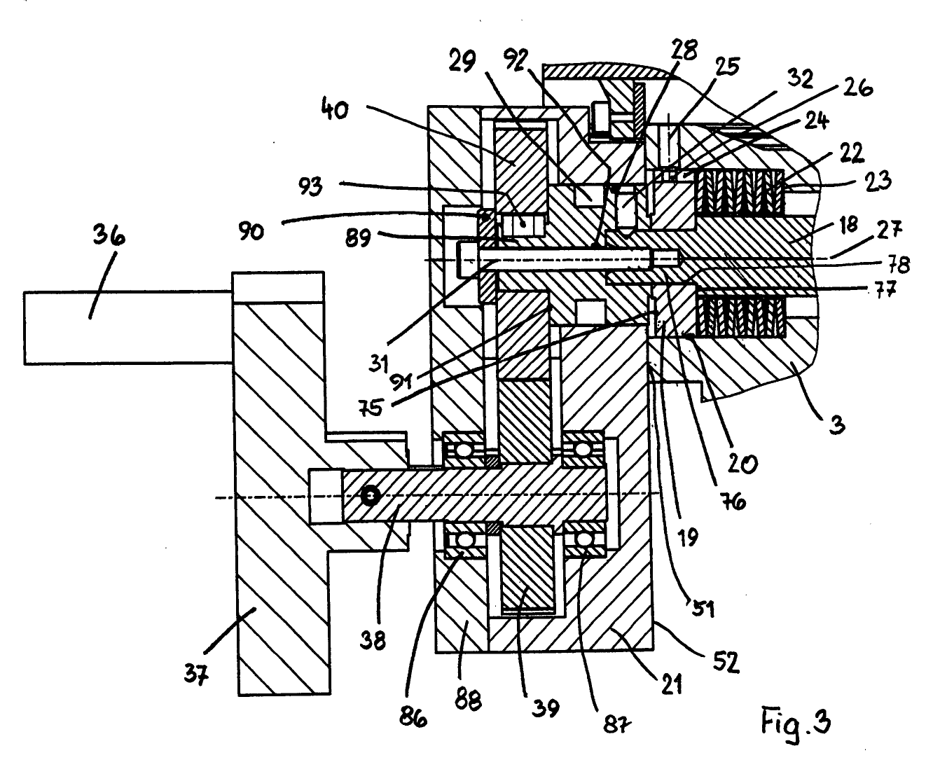

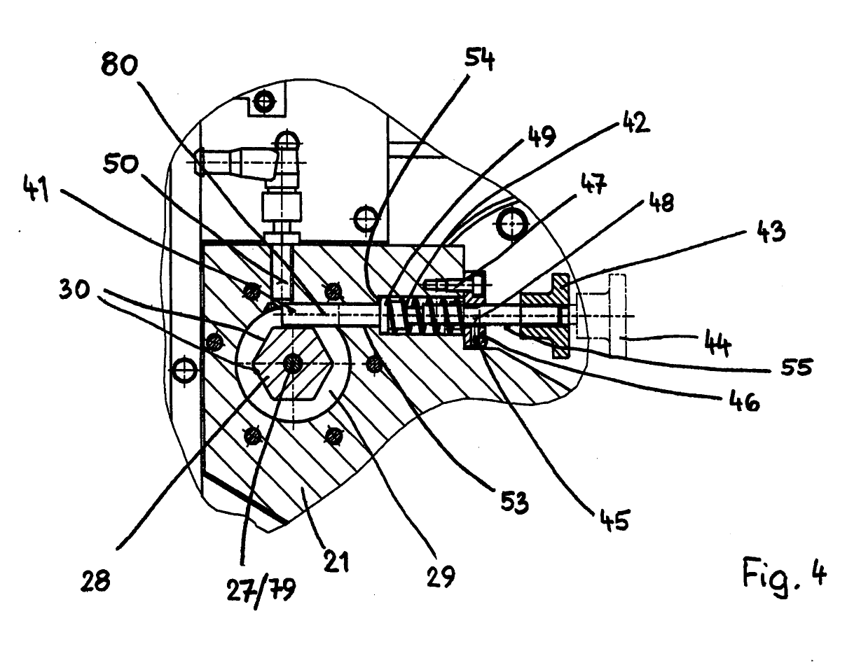

The force pressing the spring 22 against the support surface 23 on the counter-bearing carriage 3 increases progressively as the thrust collar 19 compresses the spring 22. In the mounting of the counter-bearing carriage 3, the depth of the bore 20, the width of the thrust collar 19 in the area of the outer front support surface 75 and the length of the spring 22 are adjusted in the compressed condition so that the spring force attains a desired value when the length of the compressed spring 22 plus the axial width of the thrust collar 19 in the area of the outer support surface 75 equals the depth of the bore 20. After the adjustment, the outer front support surface 75 of the thrust collar 19 and a radial support surface 51 of the counter-bearing carriage 3 are thus on a common plane. The face side of the counter-bearing carriage 3, which forms the support surface 51, is adjacent to the face side 52 of a locking housing 21. The locking housing 21 accommodates the basic locking element 28 which has an external locking groove 29 (FIGS. 3 and 4).

If the outer support surface 75 of the thrust collar 19 and the support surface 51 of the counter-bearing carriage 3 are on a common plane, the locking groove 29 assumes a specific position in the direction of the axis of rotation 27 of the threaded spindle 18. A locking rod 41 is to be inserted into said groove 29 (FIG. 4). The locking rod 41 is displaceably arranged in a bore 53 in the locking housing 21. The position of the bore 53 in the direction of the axis of rotation 27 of the threaded spindle 18 is displaced slightly downward to the right in FIG. 3 and perpendicular to the plane of projection in FIG. 4 relative to the position of the locking groove 29 when the outer support surface 75 of the thrust collar 19 bears upon the support surface 52 of the locking housing 21, so that the locking rod 41 cannot be inserted into the locking groove 29.

The locking housing 21 contains a gear train 39, 40. The gear train has a cylindrical gear wheel 39 that is splined on a shaft 38 which is pivotably supported with bearings 86, 87 in the locking housing 21 and an end cover 88 of the locking housing 21. A hand wheel 37 with a handle 36 is splined on the end of the shaft 38 which projects beyond the cover 88.

In the locking housing 21, the gear wheel 39 engages with the cylindrical gear wheel 40 which is fitted on a pivot 89 of the basic locking element 28 and secured against rotation with a key 93. The basic locking element 28 has a bore 92 and an axial support surface 91 which bears against the gear wheel 40. The screw 31 extends through bore 92 of the basic locking element 28 and is screwed to the threaded spindle 18. In this way, screw 31 connects the gear wheel 40 and the basic locking element 28 with the threaded spindle 18 through the plain washer 90. Furthermore, the screw 32 prevents the rotation of the basic locking element 28 relative to the threaded spindle 18.

When the hand wheel 37 is rotated by turning the handle 36, the rotation is transferred to the threaded spindle 18 through the shaft 38, the cylindrical gear wheels 39, 40 and the basic locking element 28. In this way, the threaded spindle 18 screws into the spindle nut 17 and thus pulls the counter-bearing carriage 3 toward the drive carriage 2. If a tool 4 is located between the conical bushings 11 and 12, a movement of the counter-bearing carriage 3 initially eliminates any play between the conical centering faces 9, 10 and the conical bushings 11, 12. When the hand wheel 37 is turned further, a clamping force builds up in the tool seat. The force increases until the clamping force plus the friction force is equal to the pre-stressing force of the spring 22.

Further turning of the hand wheel compresses the spring 22, and the thrust collar 19 and the basic locking element 28 travel to the right with the locking groove 29 in FIG. 3. As soon as the groove 29 has reached the position of the bore 53 in the locking housing 21, the locking rod 41 can be inserted into the locking groove 29.

However, the locking rod 41 normally cannot be displaced far enough toward the left in FIG. 4 so that a thrust collar 49 of the locking rod 41 bears against the end face 54 in the locking housing 21 because the locking rod 41 contacts the foot of the locking groove 29. In the embodiment, six planar locking surfaces 30 distributed evenly over the circumference of the groove are provided in the flange of the groove 29. Each of the surfaces has the same distance from the axis 79 of the basic locking element 28. The locking rod 41 can be displaced into the left end position in FIG. 4 only if one of the locking surfaces 30 is positioned parallel to the axis 80 of the locking rod 41. By turning the hand wheel 37, this position can be adjusted easily and accurately. In said position, a locking spring 42 presses the locking rod 41 into the left end position. Said position is recorded by a limit switch 50 and the signal “tool is clamped” is generated. The locking spring 42 encloses the locking rod 41 and is supported on one end on thrust collar 49 and on the other end by a washer 46 which is attached to the locking housing 21. The locking rod 41 projects through washer 46, and is provided with a locking handle 43.

FIG. 4 shows the working position of the locking rod 41 in solid lines. In this position, the locking rod 41 is held in its left end position by the locking spring 42, which is supported on one side by the thrust collar 49 and on the other side by washer 46. In said position, the locking rod bears against the plane surface 54 in the locking housing 21 with the flange 49. The limit switch 50 is used to check whether the locking rod 41 has reached the left end position, i.e., the operating position, in FIG. 4. A work piece can only be machined in said position.

To adjust the clamping force, the locking rod 41 is displaced toward the right against the force of the locking spring 42 through the locking handle in operating position 43 and the locking handle is locked in the adjustment position 44. For that purpose, the handle is rotated around its longitudinal axis 80 at a specific angle. Through said rotation, a locking pin 45 supported in washer 46 reaches the area of an annular groove 48 of the locking rod 41 and thus prevents the movement of the rod 41 to the left. During the movement of the locking rod 41 from the operating position 43 into the adjustment position 44, the locking pin 45 is in an area of the locking rod 41 where a planar surface 55 is located, which is positioned parallel to the axis 80 of the rod 41. Said planar surface 55 bears on the foot of the annular groove 48, so that the locking pin 45 permits an axial movement of the rod 41 in the area of the planar surface 55, but prevents said movement in the area of the annular groove 48. The screw 47 is one of the screws that connect the washer 46 to the locking housing 21.

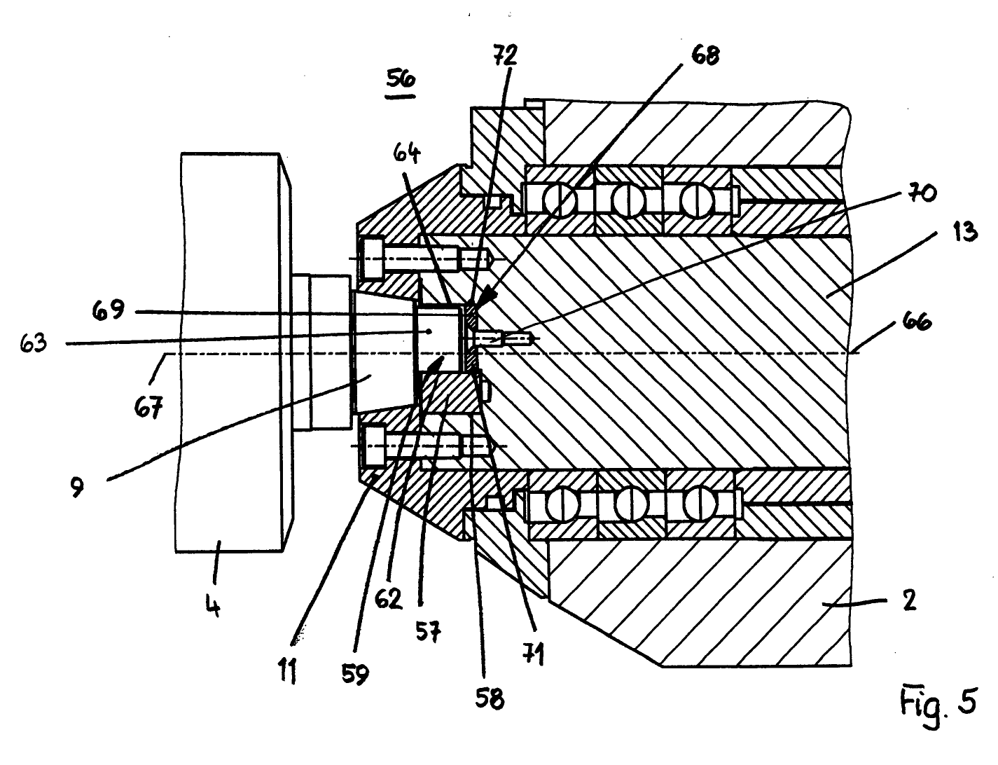

A clutch 56 (FIG. 5) between the drive spindle 13 and tool 4 is comprised of a thrust piece 57 inserted into a cylindrical bore 58 at the front face of the drive spindle on the tool side, and a pivot 59, provided at the drive side of the tool 4 in the extension of the conical centering surface 9.

The thrust piece 57 has a cylindrical form, with a section perpendicular to a cylindrical surface line consisting of a circular segment (FIGS. 6 and 7). Accordingly, the thrust piece 57 has a section 60, which is developed as a circular cylinder, and a section that is developed as a planar surface 61. The plane 61 runs parallel relative to the axis of rotation 66 of the drive spindle 13. The axis 65 of the cylindrical bore 58 has a distance “a” from the axis of rotation 66 of the drive spindle 13. The thrust piece 57 is specially coated to achieve continuously favorable friction properties and to securely prevent rust formation.

The pivot 59 of the tool 4 is also developed cylindrically. Perpendicular to a surface line, it also has the form of a circular segment so that the pivot 59 also has a planar surface 62 and a circular cylindrical surface 63. The planar surface 62 runs parallel to the axis of rotation 67 of the tool 4.

In the mounted condition, the pivot 59 projects into a recess 64 which is also affixed at the face of the drive spindle 13 on the tool side. Said recess 64 has the shape of an elongated hole. It is connected to the cylindrical bore 58. The dimensions of the clutch 56 are such that the two planar faces 61 and 62 bear against each other in operation and thus transfer the momentum from the drive spindle 13 to the tool 4.

The recess 64 contains an anti-twist element 68. It is comprised of a locking plate 69 which is connected to the drive spindle 13 through a screw 70 and bears against the bottom of the recess 64. In the embodiment, the locking plate 69 has two planar lateral surfaces 71 and 72, both of which run parallel to the axis of rotation 66 of the drive spindle 13. The surface 72 bears against the lateral wall of the recess 64 which is located opposite the thrust piece 57. The surface 71 projects into the cylindrical bore 58 such that the thrust piece 57 can be rotated by only a small angle. In the center position of said angle of rotation, there is only a small distance between the planar surfaces 71 of the locking plate 69 and 61 of the thrust piece 57. In this way, the planar surface 62 of the tool always finds a suitable position of the planar surfaces 61 of the thrust piece 57 when the tool 4 is picked up.

When the tool 4 is accommodated in the conical bushings 11, 12 it can be placed with its planar surface 62 onto the planar surface 61 of the thrust piece 57. However, this is not necessary, because the two planes are moved toward one another anyway at greater cutting loads and position themselves parallel to one another so as to avoid load bearing at the edges, i.e., so as to create surface contact. The thrust piece 57 cannot detach from the bore 58 because the smallest interior diameter of the conical bushing 11 partially covers the thrust piece 57 (see FIG. 5).

The basic principle according to which the positive clutch 56 is constructed leaves extensive play for the structural development. Primarily desired is a large lever arm “e” for the force to be transferred by the thrust piece 57, a large contact area as well as a reliable seat for the tool 4 during its production and for sharpening.

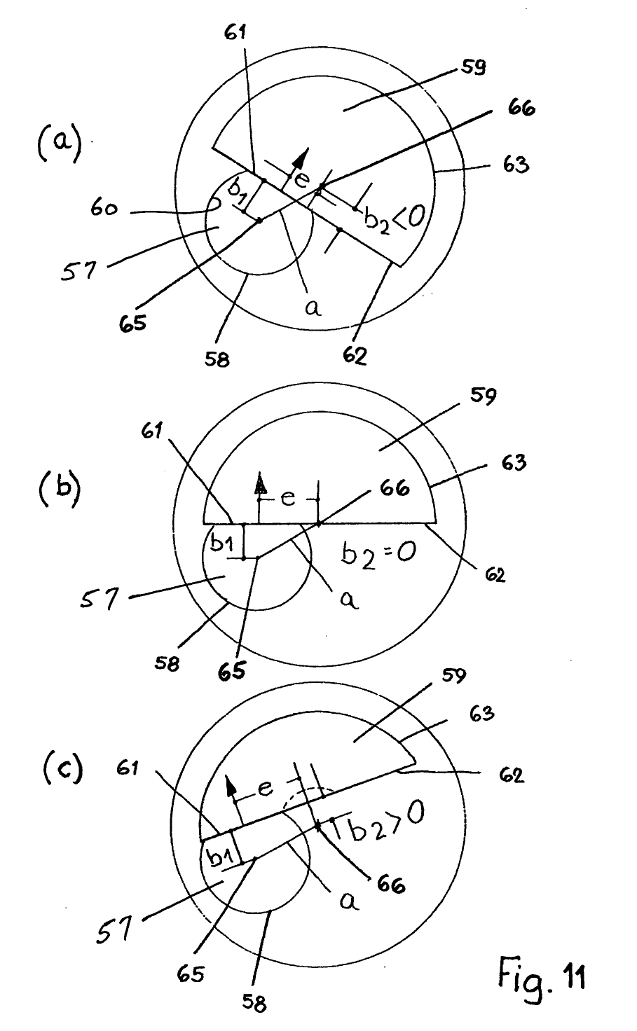

If the distance a between the spindle axis 66 and the axis 65 of the cylindrical bore 58 as well as the distance “b1” between the chord in the section in the plane of rotation of the thrust piece 57 and the axis 65 of the cylindrical bore 58 is kept constant, for example, it results in clearly different lever arms “e” for the force to be transmitted, depending on the distance “b2” between the chord in the section in the plane of rotation of the cylindrical pivot 59 and the axis of rotation 67 of the tool 4 and/or the axis of rotation 66 of the drive spindle 13. FIGS. 11(a) to 11(c) show three examples to that effect.

In the examples according to FIGS. 11(b) and 11(c), a center bore to seat the tool 4 for the sharpening process cannot be accommodated. This is insignificant for production because the planar transmission surface 62 on pivot 59 can be generated virtually in the last production step. A bushing with centering can be inserted for the sharpening of the tool 4, which has an interior cone that is placed on the conical centering surface 9 of the tool 4.

With clutch pivots similar to FIG. 11(c), it is also possible to provide a recess, for example by milling, to make space for a center bore as indicated by a dashed line in FIG. 11(c).

Apart from the distance “b2”, the distance “b1” and/or the distance between the two axes 65, 66 and/or the diameter of the bore 58 can also be varied in order to adjust the clutch 56 optimally for the intended application.

The drive carriage 2 can be displaced into the direction of the guide tracks 5, 6. The drive to that effect is performed by a motor 81 through a drive spindle 82 and a spindle nut screwed into a bearing housing 83 and a plate 84 connected to the drive carriage 2. The motor 81 is flange-mounted to a bearing housing 85, which is connected to housing 1. The bearing housing contains a clutch to connect the shaft of the motor 81 to the threaded spindle 82.

An angular position measuring system 73 can be easily mounted and serviced at the end of the drive spindle 13 (see FIG. 2).

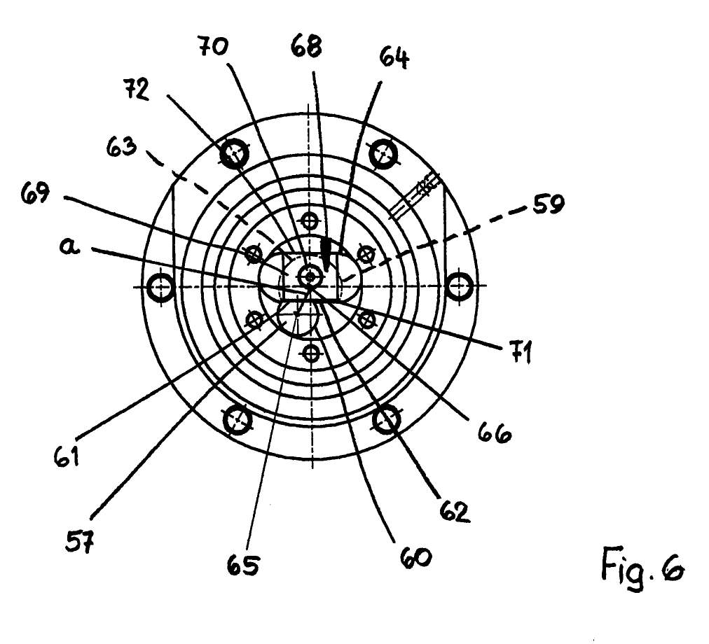

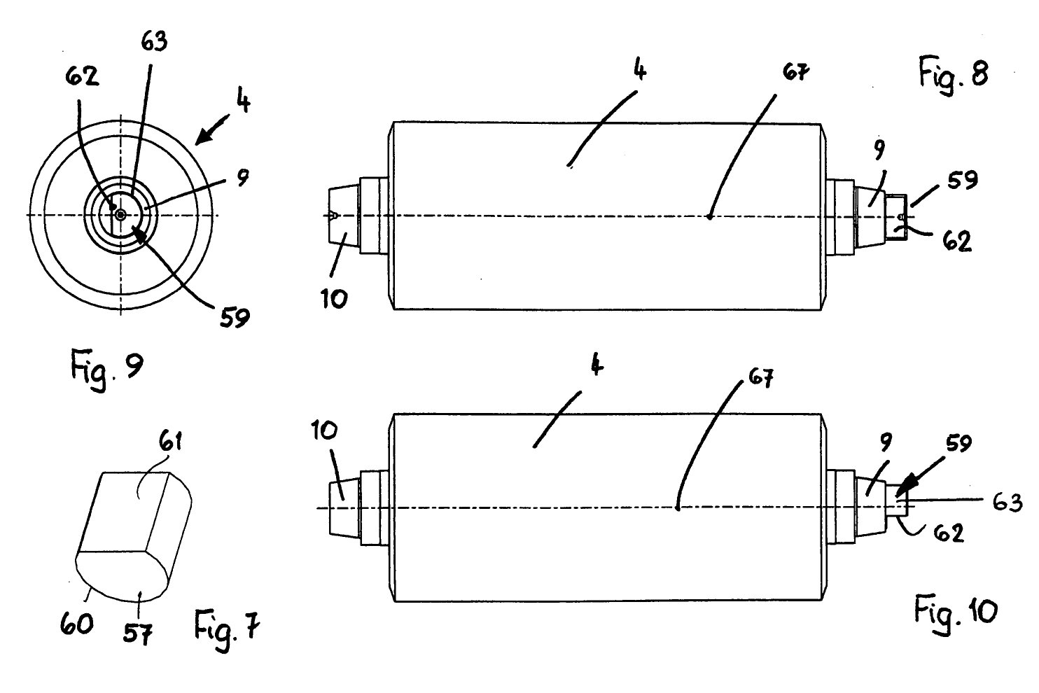

In the present invention, the tools 4 are preferably used. Said tools have conical seat- and/or centering surfaces 9, 10 at both ends, and at the drive side an additional specifically developed drive pivot 59 (FIGS. 8 to 10). The pivot 59 has the shape of a circular segment in section perpendicular to the axis of rotation 67 of the tool 4. Here, the planar surface 62 is used for the transmission of the drive moment.

The seat of the tool 4 is developed symmetrically in the proposed solution. In this way, a counter-bearing 74 (FIG. 1) on the counter-bearing carriage 3 can be developed particularly rigid. For example, a bearing 35 of the counter-bearing spindle 14 and a bearing 34 of the drive spindle 13 can be developed with equal dimensions on the tool side.

The means described in the embodiment for individual partial tasks can be replaced with other known means. For example, this applies to means for generating an axial force, for adjusting the amount of force, for seating the tool, or for the displacement of the counter-bearing carriage 3.

The present invention has a number of particularly positive characteristics:
Easy tool change
Decoupling of the tool seat from torque effects
Low axial forces are adequate
Positive clutch with surface contact to the tool drive
High tool movement accuracy
Low wear and tear solution
No power chuck device is required at the tool spindle, therefore
No imbalance-prone parts from a power chuck device
Short overall length
Tools with bores can be accommodated with an appropriate mandrel
Easy assembly and maintenance of the angular position measuring system
Thermally related changes in the length of the tool are compensated by a resilient element, such as a spring
Wide production tolerances in the area of the positive clutch
Tools with significantly different lengths can be easily accommodated

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A tool head being seat and drive for the rotary motion of a tool having first and seconds ends with a centering face near each of said ends, said tool head comprising:
a pair of rotatable seat bushings of which one of said seat bushings is arranged in a drive carriage and the other of said seat bushings is arranged in a counter-bearing, said pair of seat bushings being in alignment with each other,
said counter-bearing being part of a counter-bearing carriage which is displaceable with respect to the drive carriage by an amount sufficient to seat the tool,
whereby the tool, when located between the drive carriage and the counter-bearing carriage, is held with the centering faces in the seat bushings by a pre-adjusted axial force,
said tool head further including a rotary drive motor connectable to the tool via a tool spindle supported in the drive carriage and a positive clutch.

2. Tool head in accordance with claim 1 wherein with said tool positioned between the drive carriage and the counter-bearing carriage, the radial and axial seat of the tool is decoupled from torque effects.

3. Tool head in accordance with claim 1 further including said tool positioned between the drive carriage and the counter-bearing carriage, wherein the centering faces of the tool are developed in one piece with the tool.

4. Tool head in accordance with claim 3 wherein the centering faces are provided on a mandrel on which the tool is seated.

5. Tool head in accordance with claim 1 wherein the force required between the drive and counter-bearing carriages to displace the counter-bearing carriage toward the drive carriage and to generate the axial pre-stressing force for the tool is applied via a resilient element so that the carriages with the tool form a unit that can be displaced as a whole in the direction of the common axis of rotation of the drive spindle and the counter-bearing spindle, said unit accommodating thermal changes affecting the length of the tool without significantly affecting the pre-stressing force.

6. Tool head in accordance with claim 1 wherein the drive carriage and the counter-bearing carriage are symmetrical in the area where they connect to the tool.

7. A tool head being seat and drive for the rotary motion of a tool having first and seconds ends with a centering face near each of said ends, said tool head comprising:
a pair of rotatable seat bushings with one of said seat bushings being arranged in a drive carriage and the other in a counter-bearing, said pair of seat bushings being in alignment with each other,
a drive spindle arranged in said drive carriage, said spindle including a thrust piece having a planar catch surface,
whereby with the tool positioned in said tool head, said thrust piece and planar catch surface are coupled to a pivot portion and planar surface of the tool in a manner that said planar catch surface and said planar surface contact one another to couple the tool and the drive spindle, the surface contact between said planar catch surface and said planar surface being adjustable under load.

8. A tool for use in a tool head being seat and drive for the rotary motion of said tool, said tool head including a pair of rotatable seat bushings with one of said seat bushings being arranged in a drive carriage and the other in a counter-bearing, said pair of seat bushings being in alignment with each other, said tool head further including a drive spindle arranged in said drive carriage, said spindle including a thrust piece having a planar catch surface, said tool comprising:
a shank tool having an axis of rotation and a gear enveloping body,
a drive end and a counter-bearing end with a centering face near each of said ends,
said tool being symmetrical with respect to the gear enveloping body and the drive and counter-bearing ends, the symmetry being relative to a plane perpendicular to the axis of rotation in the center of the gear enveloping body of the tool,
wherein the distance between the drive end centering face and the gear enveloping body is the same as the distance between the counter-bearing end centering face and the gear enveloping body.
